(19) United States
(12) Patent Application Publication
(10) Pub. No.: US 2010/0058056 A1
(43) Pub. Date: Mar. 4, 2010

(54) Display system with security enhancement function

(75) Inventor: Jian-Feng Wang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOCOM TECHNOLOGY (SHENZHEN) CO., LTD.:INNOLUX DISPLAY CORP.

(21) Appl. No.: 12/150,267

(22) Filed: Apr. 25, 2008

(30) Foreign Application Priority Data
Apr. 25, 2007 (CN) 200710074211.X

(51) Int. Cl. G06T 1/00; G06T 1/60; H04L 9/32

(52) U.S. Cl. 713/168; 345/522; 345/530

(57) ABSTRACT

An exemplary display system includes a flat panel display and a host connectable to the flat panel display. The flat panel display includes a first storage unit including a first security code stored therein, a register, and a micro processing unit. The host includes a second storage unit including a second security code stored therein, and a central processing unit. The central processing unit is configured for converting the second security code to a digital signal and sending the digital signal to the register. The micro processing unit is configured to read and compare the first security code with the digital signal in the register, and output a control signal according to a result of said comparison.

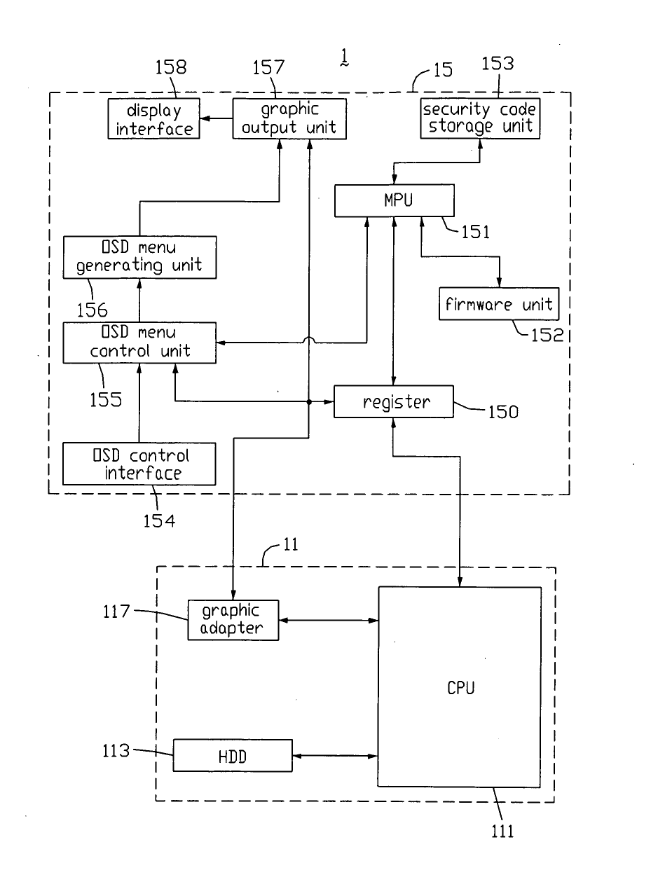

### FIELD OF THE INVENTION

The present invention relates to a display system that typically includes a flat panel display (FPD) and a host connecting to the flat panel display, with the FPD and the host cooperating such that the display system has a security enhancement function.

### GENERAL BACKGROUND

Recently, flat panel displays that are light and thin and have low power consumption characteristics have been widely used in office automation equipment, video units, and the like. However, because of their portability and low weight, flat panel displays may be easily stolen. For similar reasons, flat panel displays can be easily taken away from their proper location and used elsewhere without authority.

What is needed, therefore, is a display system that can circumvent, overcome or at least mitigate the above-described problems.

### SUMMARY

In an exemplary embodiment, a display system includes a flat panel display and a host connectable to the fiat panel display. The fiat panel display includes a first storage unit including a first security code stored therein, a register, and a micro processing unit. The host includes a second storage unit including a second security code stored therein, and a central processing unit. The central processing unit is configured for converting the second security code to a digital signal and sending the digital signal to the register. The micro processing unit is configured to read and compare the first security code with the digital signal in the register, and output a control signal according to a result of the comparison.

Other aspects, novel features and advantages will become more apparent from the following detailed description when taken in conjunction with the accompanying drawings.

### BRIEF DESCRIPTION OF THE DRAWING

In the drawing, like reference numerals designate corresponding parts.

The drawing is a block diagram of a display system according to an exemplary embodiment of the present invention.

### DETAILED DESCRIPTION OF PREFERRED EMBODIMENTS

Reference will now be made to the drawing to describe various embodiments of the present invention in detail.

Referring to the drawing, a display system 1 according to an exemplary embodiment of the present invention is shown. The display system 1 includes a host 11 and a flat panel display 15. The host 11 includes a CPU (central processing unit) 111, an HDD (hard disk driver) 113, and a graphic adapter 117. The flat panel display 15 includes a register 150, an MPU (micro processing unit) 151, a firmware unit 152, a security code storage unit 153, an OSD (on screen display) control interface 154, an OSD menu control unit 155, an OSD menu generating unit 156, a graphic output unit 157, and a display interface 158.

The CPU 111 of the host 11 can process and send digital signals to the graphic adapter 117. The graphic adapter 117 receives and converts the digital signals to corresponding graphic signals, and sends the graphic signals to the graphic output unit 157 of the flat panel display 15. The graphic output unit 157 receives and processes the graphic signals, and sends the processed graphic signals to the display interface 158.

The OSD control interface 154 can for example include a group of control buttons (not shown). The control buttons can be touched or pressed by a user from outside of the flat panel display 15. That is, the control buttons can generate demand signals according to corresponding external operations of a user. A security enhancement function of the display system 1 can be activated or deactivated according to operations applied to the OSD control interface 154 by an authorized user. The OSD menu control unit 155 can control corresponding items and functions according to the demand signals received from the OSD control interface 154. The OSD menu generating unit 156 can output OSD display signals according to control signals received from the OSD menu control unit 155. The OSD display signals are output to the display interface 158 so that the display interface 158 displays corresponding OSD menus.

The firmware unit 152 includes a first security program, a POST (power-on self test) program, and a security mark stored therein. The firmware unit 152 can for example be an EEPROM (electrically erasable programmable read-only memory) unit. When the security enhancement function is activated, the MPU 151 receives a notification signal from the OSD menu control unit 155, and the security mark is set as valid. The security code storage unit 153 includes a first security code stored therein in the form of plain text. If the security mark is valid, the MPU 151 starts the POST program when the flat panel display 15 is powered on, detects the security mark, and periodically runs the first security program.

The HDD 113 includes a second security program installed therein, and a second security code stored therein. The second security code is an encrypted code of the first security code. That is, the second security code corresponds to an encrypted form of the first security code. When a starting signal is input to the CPU 111, the CPU 111 runs the second security program periodically. A period between runnings of the second security program is less than a period between runnings of the first security program. When the display system 1 is powered on, the CPU 111 reads the second security code from the HDD 113, decrypts the second security code, and sends the decrypted second security code to the register 150.

When the first security program is run, the MPU 151 reads the first security code from the security code storage unit 153, and compares the first security code with the decrypted second security code in the register 150. If the first security code matches the decrypted second security code, the MPU 151 outputs a normal work signal to make the flat panel display 15 normally operable, and deletes the decrypted second security code from the register 150. If the first security code does not match the decrypted second security code, the MPU 151 rereads the first security code and re-compares the first security code with the decrypted second security code. If the first security code continuously does not match the decrypted second security code a predetermined threshold number of times, for example three times, the MPU 151 outputs a confirmation signal to the OSD menu control unit 155. The OSD menu control unit 155 receives the confirmation signal, and the OSD menu generating unit 156 generates a corresponding OSD menu displayed on the display interface 158 to prompt the user to input whether the second security program is properly installed and whether the proper second security code is stored. For example, the user may, by appropriate input, confirm that the second security program is properly installed and that the proper second security code is stored. If so a prompt result input by the user and sent to the MPU 151 is positive, and the flat panel display 15 restarts to display normally. If a prompt result is negative, the MPU 151 outputs a shut down signal to shut down the flat panel display 15. In one embodiment, if a positive prompt result is not achieved within a predefined period of time, the MPU 151 automatically determines that the prompt result is negative.

Typically, a protocol called DDCCI (display data channel command interface) protocol is utilized for communication between the host 11 and the flat panel display 15. DDCCI protocol can realize OSD operations displayed by the flat panel display 15 by allowing external input devices (e.g., a keyboard or mouse, not shown) to convey a user's instructions to the display system 1. That is, the security enhancement function of the display system 1 can be activated or deactivated and the first security code and the second security code can be modified via DDCCI protocol.

The first security code and the second security code can be modified as follows. When a security code modification signal is sent to the CPU 111 from the OSD control interface 154, the CPU 111 generates a dialogue displayed on the display interface 158. When the current first security code and a new first security code are input, the CPU 111 reads and decrypts the current second security code. The current first security code is compared with the decrypted current second security code. If the current first security code matches the decrypted current second security code, the new first security code replaces the current first security code stored in the firmware unit 152, and is correspondingly encrypted and stored in the HDD 113 to replace the current second security code. If the current first security code does not match the decrypted current second security code, the current first security code and the current second security code are maintained, and the new first security code is disregarded by the CPU 111.

For further security, the security mark can be preset to be invalid when the first security code is null; i.e. when the security code storage unit 153 does not include a first security code.

When the flat panel display 15 is connected to the host 11, the host 11 can send a proper decrypted second security code to the register 150, and the flat panel display 15 can be operated normally if the first security code matches the decrypted second security code.

When the flat panel display 15 is connected to another host (not shown) without the second security program installed therein and/or without the second security code stored therein, the register 150 cannot receive a second security code, and/or cannot receive the proper decrypted second security code. Thus a comparison between the first security code and a decrypted second security code of the other host cannot be made by the MPU 151, and/or a comparison between the first security code and a decrypted second security code of the other host yields a “no match” result. In either case, the MPU outputs a confirmation signal to the OSD menu control unit 155. The OSD menu control unit 155 receives the confirmation signal, and controls the OSD menu generating unit 156 to generate a corresponding OSD menu displayed on the display interface 158 to prompt a user to confirm whether the second security program is properly installed in the other host and whether the proper second security code is stored in the other host. In general, an unauthorized user of the flat panel display 15 cannot access the second security program of the host 11, and/or cannot access the particular second security code of the host 11. Thus a prompt result is negative, and the MPU 151 outputs a power-off signal to shut down the flat panel display 15.

In summary, in the display system 1, when the security enhancement function is activated, the first security program is periodically run, and the first security code stored in the flat panel display 15 is compared with the decrypted security second code stored in the register 150. If the flat panel display 15 is stolen or is connected to another host without the second security program properly installed therein and/or without the proper second security code stored therein, the new display system constituted by the flat panel display 15 and the other host cannot pass the security comparison. Thus, the flat panel display 15 cannot be operated normally. It is believed that such kind of display system 1 with the above-described security enhancement function can help deter people from stealing the flat panel display 15 or using the flat panel display 15 without authorization. That is, the security enhancement function makes the display system 1 including the flat panel display 15 more secure.

In alternative embodiments, the flat panel display 15 of the display system 1 may instead be another kind of display, for example, a CRT (cathode ray tube) display.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display system comprising:
a flat panel display comprising:
a first storage unit comprising a first security code stored therein;
a register; and
a micro processing unit (MPU); and
a host connectable to the flat panel display, the host comprising:
a second storage unit comprising a second security code stored therein; and
a central processing unit (CPU) configured for converting the second security code to a digital signal and sending the digital signal to the register;
wherein the MPU is configured to read and compare the first security code with the digital signal in the register, and output a control signal according to a result of the comparison.

2. The display system of claim 1, wherein the flat panel display further comprises a firmware unit, the firmware unit being configured for driving the MPU to launch the comparison for at least once.

3. The display system of claim 2, wherein the firmware unit is an electrically erasable programmable read-only memory (EEPROM) unit.

4. The display system of claim 2, wherein the firmware unit comprises a security mark stored therein.

5. The display system of claim 4, wherein the MPU is configured to launch the comparison for at least once if the security mark is valid, and ignore the comparison if the security mark is invalid.

6. The display system of claim 1, wherein the CPU is configured to convert the second security code to the digital signal when the display system is powered on.

7. The display system of claim 1, wherein the first security code is stored in the form of plain text, and the second security code corresponds to an encrypted form of the first security code.

8. The display system of claim 1, wherein the MPU is configured to output the control signal to make the flat panel display normally operable if the first security code matches the digital signal.

9. The display system of claim 8, wherein the MPU is configured to delete the digital signal from the register.

10. The display system of claim 1, wherein the MPU is configured to output the control signal for prompting whether the second security code is properly stored if the first security code does not match the digital signal.

11. The display system of claim 1, wherein the MPU is configured to output the control signal for shutting down the flat panel display if the first security code does not match the digital signal.

12. The display system of claim 1, wherein the first security code and the second security code are modifiable.

13. The display system of claim 1, wherein flat panel display further comprises an OSD (on screen display) assembly, the OSD assembly comprising an OSD control interface, an OSD menu control unit, and an OSD menu generating unit.

14. The display system of claim 12, wherein the OSD menu control unit is configured to generate an OSD menu control signal to the OSD menu generating unit according to a demand signal received from the OSD control interface.

15. The display system of claim 13, wherein the OSD menu generating unit is configured to receive the OSD menu control signal and output an OSD display signal.

16. The display system of claim 14, wherein the flat panel display further comprises a display interface, the display interface being configured to receive the OSD display signal and display corresponding contents.

17. A display system comprising:
a flat panel display comprising:
a first storage unit configured for providing a first security code;
a register; and
a micro processing unit (MPU);
a host connectable to the flat panel display, the host comprising:
a second storage unit configured for providing a second security code, the second security code corresponding to an encrypted form of the first security code; and
a CPU (central processing unit) configured for decrypting the second security code and sending the decrypted second security code to the register;
wherein the MPU is configured to compare the first security code with the decrypted second security code, and determine that the flat panel display is to be operated normally if the first security code matches the decrypted second security code or that the flat panel display is not to be operated if the first security code does not match the decrypted second security code.

18. The display system of claim 17, wherein the flat panel display further comprises a firmware unit, the firmware unit being configured for driving the MPU to launch the comparison for at least once.

19. The display system of claim 18, wherein the firmware unit comprises a security mark stored therein, and the MPU is configured to launch the comparison for at least once if the security mark is valid, and ignore said comparison if the security mark is invalid.

20. The display system of claim 17, wherein the MPU is configured to output the control signal for prompting whether the second security code is properly stored or shutting down the flat panel display if the first security code does not match the digital signal.
